(19) United States
(12) Patent Application Publication
(10) Pub. No.: US 2017/0195980 A1
(43) Pub. Date: Jul. 6, 2017

(54) SYNCHRONIZING CLOCKS IN A NETWORK

(71) Applicant: Bose Corporation, Framingham, MA (US)

(72) Inventors: Pankaj Aggarwal, Waltham, MA (US); Carlos Guilherme Batista Heil, Norwood, MA (US); George Kontopidis, Sherborn, MA (US); Scott Stinson, Framingham, MA (US)

(21) Appl. No.: 14/985,773

(22) Filed: Dec. 31, 2015

(51) Int. Cl. H04W 56/00

(52) U.S. Cl. CPC H04W 56/007; H04W 56/0015; H04W 56/005; H04W 84/12

(57) ABSTRACT

The subject technology can be embodied in a method that includes receiving, at a first device, a first signal and a second signal, the first and second signals being transmitted from a second device at two different time points. The method also includes obtaining, by the first device, transmission time-gap information representing a difference between the two different time points, and determining reception time-gap information representing a difference between two time points, the reception time-gap information being calculated based on a first clock signal. The method further includes determining, based on the transmission time-gap information and the reception time-gap information, at least one parameter that represents the difference between the first clock signal and a second clock signal associated with the second device, and generating, based on the at least one parameter, one or more control signals for reducing the difference between the first and second clock signals.

### TECHNICAL FIELD

This disclosure generally relates to synchronizing clocks in devices connected to one another over a network.

### BACKGROUND

In various applications, multiple devices connected in a network may each have an internal clock that runs independently of other clocks in the network. For example, in a digital device, the internal clock can generate a signal that synchronizes different parts of circuitry within the device. In some applications, the clock of one device may have to be synchronized to a clock of another device for the devices to operate properly. Such clock synchronization can be achieved, using, for example, Network Time Protocol (NTP), which requires computation of a round-trip delay time between two network-connected devices.

### SUMMARY

In one aspect, this document features a computer-implemented method for reducing a difference between two clock signals. The method includes receiving, at a first device, a first signal and a second signal, wherein the first and second signals are transmitted from a second device over a wireless channel at two different time points. The method also includes obtaining, by the first device, transmission time-gap information representing a difference between the two different time points, and determining, using one or more processors of the first device, reception time-gap information representing a difference between two time points at which the first signal and the second signal are received, respectively, at the first device. The reception time-gap information is calculated based on a first clock signal associated with the first device. The method further includes determining, based on the transmission time-gap information and the reception time-gap information, at least one parameter that represents the difference between the first clock signal and a second clock signal associated with the second device, and generating, based on the at least one parameter, one or more control signals for reducing the difference between the first and second clock signals.

In another aspect, this document features a system that includes a clock, a receiver device, and one or more processing devices. The clock is configured to generate a first clock signal. The receiver device is configured to receive a first signal and a second signal, wherein the first and second signals are transmitted from a second device over a wireless channel at two different time points. The one or more processing devices are configured to obtain transmission time-gap information representing a difference between the two different time points, and determine reception time-gap information representing a difference between two time points at which the first signal and the second signal are received, respectively, at the receiver device. The reception time-gap information is calculated based on the first clock signal. The one or more processing devices are also configured to determine, based on the transmission time-gap information and the reception time-gap information, at least one parameter that represents the difference between the first clock signal and a second clock signal associated with the second device, and generate, based on the at least one parameter, one or more control signals for reducing the difference between the first and second clock signals.

In another aspect, this document features one or more machine-readable storage devices having encoded thereon computer readable instructions for causing one or more processors to perform various operations. The operations include receiving, at a first device, a first signal and a second signal, wherein the first and second signals are transmitted from a second device over a wireless channel at two different time points. The operations also include obtaining, by the first device, transmission time-gap information representing a difference between the two different time points, and determining reception time-gap information representing a difference between two time points at which the first signal and the second signal are received, respectively, at the first device. The reception time-gap information is calculated based on a first clock signal associated with the first device. The operations further include determining, based on the transmission time-gap information and the reception time-gap information, at least one parameter that represents the difference between the first clock signal and a second clock signal associated with the second device, and generating, based on the at least one parameter, one or more control signals for reducing the difference between the first and second clock signals.

Implementations of the above aspects may include one or more of the following features.

The difference between the two time points can be calculated based on the second clock signal associated with the second device. The at least one parameter represents an offset between the first and second clock signals. At least one of the control signals can be configured to adjust the first clock signal such that the offset between the first and second clock signals is reduced. The at least one parameter can represent a difference in clock-speeds of the first and second clock signals, respectively. At least one of the control signals can be configured to adjust the clock-speed of the first clock such that the difference in clock-speeds is reduced. Each of the first and second devices can be a speaker associated with an audio system. The first and second signals can be transmitted from the second device multiple times. Multiple sets of one or more control signals can be generated, each of which is generated based on a corresponding set of the first and second signals. This can include receiving, at the first device, a third signal that is transmitted from the second device, obtaining, by the first device, transmission time-gap information representing a difference between transmission times of the second signal and the third signal, determining a second reception time-gap information representing a difference between two time points at which the second signal and the third signal are received, respectively, at the first device, in accordance with the first clock signal associated with the first device, and determining the at least one parameter based also on the second reception time-gap information. The at least one parameter can be determined multiple times, and the one or more control signals can be generated based on the multiple values of the at least one parameter. The first and second signals can be transmitted over an infrared portion or a radio frequency portion of electromagnetic spectrum. A wavelength associated with the first signal can be substantially equal to a wavelength associated with the second signal. The second clock signal can be a master-clock signal for a network of wireless devices. The first and second signals can be transmitted as portions of corresponding clear-to-send (CTS) packets. Each of the CTS packets is a CTS-to-self packet in which an address field includes an address of the second device.

Various implementations described herein may provide one or more of the following advantages.

By obviating the need for calculation of round-trip delay, the technology described herein may provide a synchronization technique that is faster and/or more accurate. For example, in the presence of asymmetric delay (where the one way propagation time from a first device to a second device is significantly different from the one way propagation time from the second device to the first device) a clock offset calculated using the techniques described herein may be more accurate than that computed using a round-trip delay. Also, because clock synchronization can be done using one way transmissions only, the fast synchronization process may allow frequent corrections of offsets between two clocks, at a rate higher than that afforded by a process based on calculating round-trip delays. Further, a device may be able to calculate a clock drift independently without having to wait for another device to provide that information.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### DESCRIPTION OF THE DRAWINGS

FIG. 1 is an example of an environment (including multiple wireless-enabled speakers) where the techniques described herein may be used.

FIG. 2 is a schematic diagram illustrating calculation of round-trip delay between two devices.

FIG. 3 is a schematic diagram illustrating a time synchronization process in accordance with the techniques described herein.

FIG. 4 is a flowchart of an example process for reducing a difference between two clock signals.

FIGS. 5A and 5B are example plots illustrating the effects of the techniques described herein.

### DETAILED DESCRIPTION

This document describes a clock synchronization technique in which the difference between two clock signals are reduced without having to calculate a round-trip time delay between the corresponding devices. Rather, the synchronization techniques described herein includes calculating the offset between two clocks based on receiving multiple signals that are transmitted from another device at predetermined intervals. For example, a transmitting device transmits two consecutive signals that are separated by a predetermined time interval as calculated based on a clock of the transmitting device. A receiving device, which knows the predetermined time interval, receives the two signals separated in time by a reception interval as calculated using the clock of the receiving device. If the reception interval is substantially equal to the predetermined interval, the clock of the receiving device is determined to be substantially in synchrony with the clock of the transmitting device. On the other hand, if the reception interval is more or less than the predetermined interval, the clock of the receiving device is determined to be slower or faster, respectively, than the clock of the transmitting device, and either or both clocks may be adjusted accordingly to reduce the difference between the clocks.

Devices communicating with one another often have their own respective internal clocks that time operations in the circuitries of the corresponding devices. For example, a device that includes digital circuits can include a clock generator for generating a clock signal that oscillates between a high and a low state. Such a clock signal can be used, for example, to coordinate operations in the digital circuits. In some case, a clock signal can be generated in the form of a substantially continuous periodic square wave with a predetermined (e.g., 50%) duty cycle. A particular clock signal can have a constant frequency, which may be adjustable, for example, via a control signal provided to the clock generator circuit.

In some cases, the clocks corresponding to two different devices may need to be synchronized for the two devices to operate in conjunction with each other for their intended purposes. For example, in synchronous communication systems, the respective clocks of two devices may have to be synchronized with one another for data transmission between the devices. In another example, in order for two or more acoustic transducers (e.g., speakers) to generate the same acoustic output with substantially no delay (or with a deterministic delay), the individual internal clocks of the respective acoustic transducers may have to be synchronized with one another.

Two clocks that are set to run synchronously often desynchronize from each other. For example, even small differences in clock-speed may cause the clocks to drift apart gradually over time. This phenomena is often referred to as clock drift, and the resulting difference between the two clocks is often referred to as skew. Clock synchronization may entail periodic adjustment of two clocks such that the skew between the two clocks is reduced. In some cases, clock synchronization can include adjusting a frequency of a clock signal such that the adjusted clock signal produces clock pulses substantially at the same frequency as another clock. This is referred to as frequency synchronization. In some cases, phase synchronization can also be added to two waveforms such that the two waveforms have not only the same frequency, but also substantially identical phase angles at a given time point. One or both of frequency synchronization and phase synchronization between two signals may be achieved using the synchronization techniques described herein.

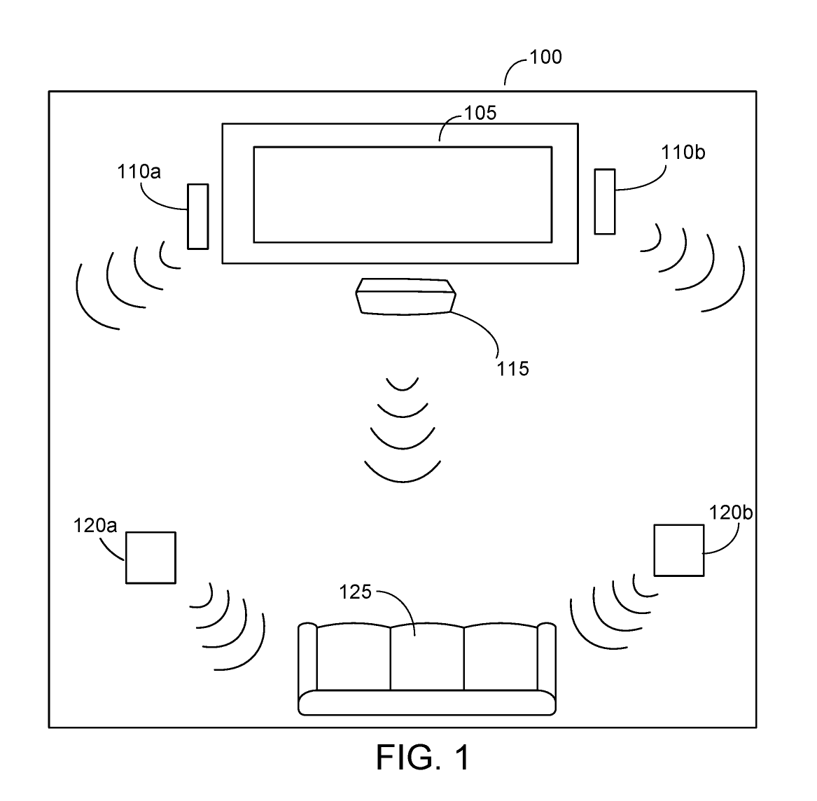

FIG. 1 is an example of an environment 100 where the techniques described herein may be used. Specifically, the environment 100 includes an acoustic system that includes two front speakers 110a and 110b (110, in general), a mid-channel speaker 115, and two rear speakers 120a and 120b (120, in general) that provides a target acoustic distribution at one or more locations (e.g., the sofa 125) within the environment 100. In some implementations, at least some of the speakers 110, 115, and 120 may be connected to each other over a wireless network such as a Wi-Fi™ network or Bluetooth® network. Each of the individual speakers may include a corresponding internal clock that times the digital circuitry disposed in the speaker. The example of FIG. 1 should not be considered limiting, as other systems are also within the scope of the technology described herein. For example, an acoustic system may have more or less speakers than that illustrated in FIG. 1. The synchronization technology described herein may also be used for other systems (e.g., communication networks) where two independent clock signals are synchronized for the systems to work for their intended purposes.

In an acoustic system such as shown in FIG. 1, the internal clocks of multiple speakers may have to be synchronized with one another in order to deliver a target acoustic experience. For example, the clocks between a left speaker (e.g., 110a) and a right speaker (e.g., 110b) may have to be synchronized such that there is no delay between the acoustic outputs coming out of the speakers. In some implementations, the respective clocks of the speakers may also have to be synchronized to introduce a deterministic delay between the speakers. For example, to steer the sound output from one speaker (e.g., 120a) to another (e.g., 120b), a deterministic delay may be introduced between the output of the speaker 120a and the output of the speaker 120b. In order to implement the deterministic delay, the clocks of the respective speakers may have to be synchronized. The synchronization can include, for example, synchronizing the clocks in the left and right speakers, synchronizing the clocks in the front and rear speakers, and/or synchronizing the clocks in any two or more speakers in the environment 100.

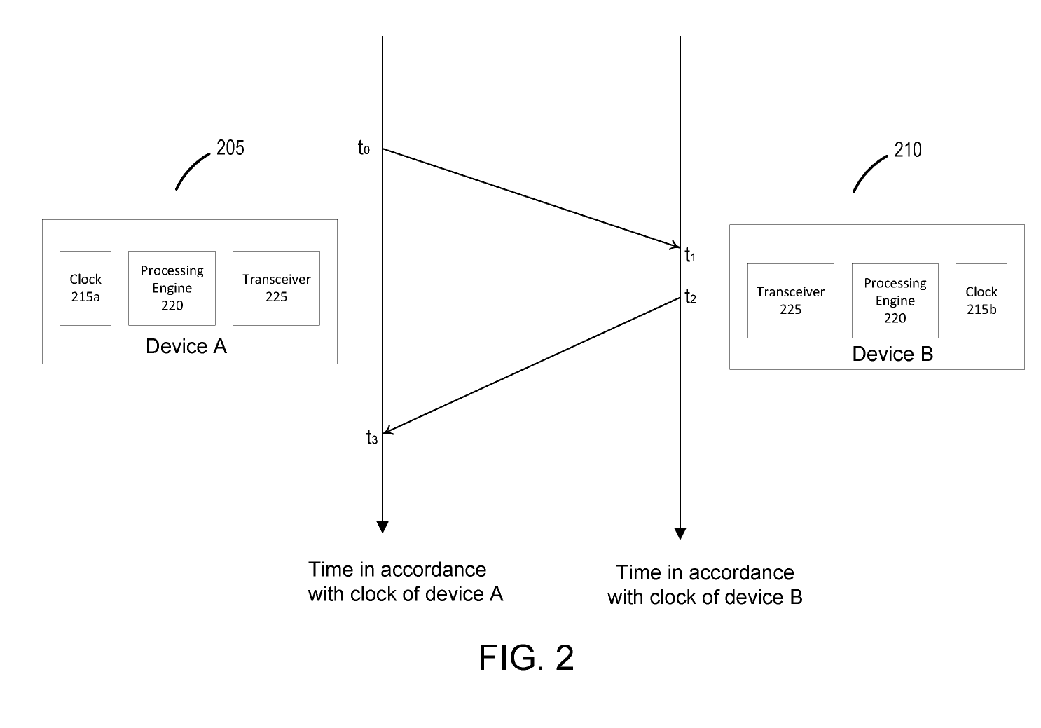

One way to synchronize the clocks of two devices includes calculating an offset between the clocks via calculating a round-trip delay for signal propagation between the two devices. FIG. 2 is a schematic diagram illustrating calculation of round-trip delay between two devices 205 and 210. Each of the devices 205 and 210 can include an internal clock and a processing engine 220. The internal clock of device A 205 is depicted as 215a, and the internal clock of device B 210 is depicted as 215b. In general, the internal clocks are herein denoted by the reference numeral 215. The processing engine 220 can use a transceiver 225 of the device to exchange (e.g., transmit and receive) signals with another device in order to calculate a round-trip delay between the two devices. The round trip delay can be calculated, for example, using protocols such as the Network Time Protocol (NTP).

NTP can be used to synchronize one or more computing devices connected in a network to within a few milliseconds of a global time standard (e.g., the Coordinated Universal Time (UTC)). FIG. 2 describes calculation of the round-trip delay as calculated in the NTP. To synchronize the clock of a particular device (e.g., the device A, 205) with that of another device (e.g., the device B, 210) the particular device 205 can be configured to compute a round-trip delay time and an offset between the corresponding clocks. In the example of FIG. 2, the round-trip delay 6 can be computed as:

δ=(t₃−t₀)−(t₂−t₁) (1)

where t₀ is the time point (as per a time stamp in accordance with the clock 215a of the device 205) at which the device 205 transmits a data packet,
t₁ is the time point (as per a time stamp in accordance with the clock 215b of the device 210) at which the device 210 receives the data packet,
t₂ is the timestamp (as per a time stamp in accordance with the clock 215b of the device 210) at which the device 210 transmits a response packet (e.g., an acknowledgement), and
t₃ is the timestamp (as per a time stamp in accordance with the clock 215a of the device 205) at which the device 205 receives the response packet.
Therefore, the time elapsed at the device 205 between the transmission of the data packet and the reception of the response packet is given by (t₃−t₀), and the time taken by the device 210 to transmit the response packet following reception of the data packet is given by (t₂−t₁). Assuming substantially equal delay between the forward path (i.e., from the device 205 to 210) and the return path (i.e., from the device 210 to the device 205), the offset between the two clocks is given by:

$$θ = \frac{( {t}_{1} - {t}_{0} ) + ( {t}_{2} - {t}_{3} )}{2} \qquad ( 2 )$$

Once the offset is determined, the clock frequency of one or both clocks may be adjusted to reduce the offset.

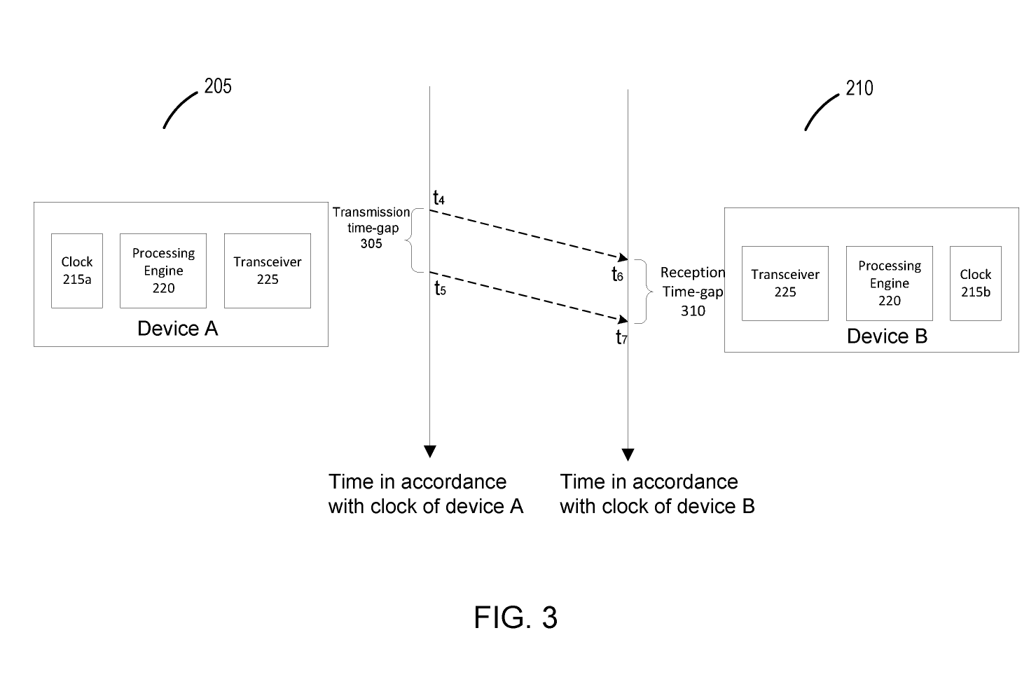

In some cases, calculating the offset based on the round-trip delay can lead to inaccuracies. For example, if the delay is asymmetric (i.e., the delay in the forward path is substantially different from the delay in the return path), an offset calculated using equation (2) may not accurately represent the actual offset between the two clocks. Further, if the asymmetry in the delays is non-deterministic (e.g., varies with time), an inaccurate offset estimate cannot be corrected by adding a bias. Also, in networks where data packets are transmitted based on a contention mechanism, round-trip delay calculations may be error-prone die to a probabilistic nature of the contention mechanism. In some implementations, the inaccuracies due to asymmetric delays and/or round trip delay estimations may be substantially eliminated by calculating the offset based on one-way transmissions only. Such a time synchronization scheme is depicted schematically in FIG. 3.

In the scheme schematically depicted in FIG. 3, the transmitting device transmits multiple signals separated by a predetermined time gap. In the example of FIG. 3, the transmitting device 205 transmits two synchronization signals (each representing one or more data packets) at time points t₄ and t₅, respectively. The signals can be transmitted, for example, via a transceiver 225 of the transmitting device 205 over a wireless channel separating the transmitting device 205 and the receiving device 210. The transmission of the signals can be controlled by the processing engine 220 of the transmitting device 205. Because the signals take a finite duration of time to be transmitted from the device 205, one time point in that finite duration (e.g., the time point at which the transmission is initiated) may be considered as the time point for the transmission for the purposes described herein. The predetermined gap between the transmission time points is referred to as a transmission time-gap 305. In some implementations, the transmission time-gap 305 can be calculated in accordance with the clock 215a of the transmitting device 205. In some implementations, the transmission time-gap may be based on a standardized clock (e.g., the UTC).

In some implementations, the transmitting device 205 can be a master node in a network. In such a case, other nodes in the network can be configured to synchronize with the clock of the master node. In some implementations, a master node may allow multiple other nodes to synchronize with the clock of the master node simultaneously by transmitting the synchronization signals (possibly as a part of a beacon transmission) in a broadcast mode. In some implementations, after a node synchronizes its clock with that of the master node, the node may act as the transmitting device 205 and transmit synchronization signals to downstream nodes.

In some implementations, a transmitting device 205 can employ a packet protection mechanism to ensure that the synchronization signals are properly received by the receiving device 210. For example, prior to transmitting the synchronization signals, the transmitting device 205 can broadcast a signal to other nodes to reserve the medium for a predetermined time period. This can be done, for example, by transmitting a clear-to-send (CTS) packet that notifies the other nodes to stop transmitting over the channel (or contend for the channel) for a predetermined amount of time. Such CTS packets can be sent to one particular node (e.g., the receiving device 210), or addressed to the transmitting device itself. When a transmitting device 205 uses its own address for addressing a CTS packet, such a packet is referred to as a CTS-to-self packet. Other channel reservation techniques may also be used. In some implementations, by transmitting a CTS packet prior to transmitting the synchronization signals, the transmitting device 205 reduces the probability of the synchronization packets being lost or delayed due to collisions with other packets in the medium. In the particular example of FIG. 3, the transmitting device 205 can be configured to reserve the medium for a time period that encompasses the time points t₄ and t₇ (possibly with appropriate guard periods, as needed) such that the channel between the devices 205 and 210 remains contention free during the synchronization signal transmissions.

In some implementations, information about the predetermined time gap may be made available to the devices connected to a network (e.g., using a beacon signal) such that any device receiving one synchronization signal at any given time expects a second synchronization signal after the predetermined time gap. Information about the transmission time-gap 305 can also be provided to the receiving device 210 by the transmitting device 205. For example, a data packet transmitted from the device 205 to the device 210 via the first signal transmitted at t₄ (or separately) can include information about the transmission time-gap 305. The value of the transmission time-gap 305 can be determined based on various parameters such as type of network, nature of medium, distance between the two devices, and expected rate of clock drift between the two devices. In one example, for two devices that are connected over a Wi-Fi™ connection, the value of the transmission time-gap 305 can be 10 μs.

When the first signal (one that was transmitted from the transmitting device at t₄) is received at the receiving device 210, rather than transmitting a response signal or packet, the receiving device 210 continues to wait for the second signal (one that was transmitted from the transmitting device at t₅). As described above, the receiving device 210 may have prior knowledge about the transmission time-gap 305 associated with the two signals, or may be made aware of the transmission time-gap 305 by the transmitting device 205. In some implementations, the transceiver 225 of the receiving device 210, upon receipt of the first signal, can notify the processing engine 220, which determines that the received signal is a synchronization signal, and continues to wait for the receipt of the second synchronization signal. In some implementations, the wait can be terminated if the second signal is not received within a threshold period after receiving the first signal. For example, if the second signal is not received within a time period twice the length of the transmission time-gap 305, the processing engine 220 of the second device 210 may determine that the second signal has been lost, and notify the transmitting device 205 accordingly. The waiting period can be experimentally or theoretically determined based on various parameters associated with data transmission between the two devices 205 and 210.

In some implementations, Once the two signals are received at the receiving device 210 (e.g., at time points t₆ and t₇, respectively), the processing engine 220 of the receiving device 210 can be configured to determine the time interval between the receipt of the two signals. This interval can be referred to as the reception time-gap 310. The reception time-gap 310 can be calculated based on the clock 215b of the receiving device. Because the device 210 is aware of the transmission time-gap (also referred to as the expected time-gap), the reception time-gap 310 can be compared with the transmission time-gap 305 to determine whether the clock 215b is running slower or faster than the clock 215a. For example, if the reception time-gap 310, as calculated using the clock 215b of the receiving device 210, is longer than the transmission time-gap 305, the processing engine 220 of the receiving device can be configured to determine that the clock 215b is running faster than the clock (e.g., the clock 215a, or a standardized clock such as the UTC) used in calculating the transmission time-gap 305. On the other hand, if the reception time-gap 310 is shorter than the transmission time-gap 305, the processing engine 220 of the receiving device can be configured to determine that the clock 215b is running slower than the clock used in calculating the transmission time-gap 305.

In some implementations, the reception time-gap information can be calculated based on more than two signals transmitted from the transmitting device 205. For example, if the transmitting device 205 transmits three synchronization signals, the first time gap between the reception of the first and second signals at the receiving device 210, and the second time gap between the reception of the second and third signals at the receiving device 210 can be used in computing the reception time-gap 310. For example, in such a case, the reception time-gap 310 may be calculated as an average of the first time gap and the second time gap.

In some implementations, the absolute difference between the transmission time-gap (also referred to as an expected time-gap) 305 and the reception time-gap 310 represents the amount of drift of the clock 215b with respect to the clock used in calculating the transmission time-gap 305. Based on the determined difference, the clocks of the receiving device 210 and/or the transmitting device 205 may be adjusted to reduce the difference between the two clocks. One or more control signals can be generated, for example, by the processing engine 220 of the receiving device 210, for reducing the difference between the clocks. In some implementations, the processing engine 220 of the receiving device can generate a control signal to adjust the clock 215b of the receiving device 210. In some implementations, the processing engine 220 of the receiving device can transmit a control signal to the transmitting device 205, wherein the control signal is configured to adjust the clock 215a of the receiving device to reduce the difference between the clocks.

In some implementations, the clocks are adjusted via an iterative process to reduce any disruptive effect on the devices. For example, a one-time 1 ms drift correction in an acoustic transducer may introduce disruptive effects such as audible distortions, and therefore degrade user-experience. Instead, the 1 ms drift can be corrected in an iterative process where small corrections are spaced out in time. For example, the 1 ms drift can be corrected by introducing a 0.1 ms correction every 1 ms, and spreading out the correction process over a 10 ms period. In some implementations, such iterative corrections can minimize any disruptive effects on the user experience and/or functioning of the devices.

In some implementations, even after two clocks are substantially synchronized with one another, they may drift apart again in the absence of additional corrections. For example, if there is an inherent difference in the individual clock-speeds, the clocks may drift apart again in the absence of additional corrections. Therefore, in some implementations, the synchronization process described above can be repeated, possibly in periodic cycles. The frequency of the repeated corrections can depend on various factors, including, for example, the difference in clock-speeds of the two clocks. In one example, the synchronization process described above can be repeated every 10 ms. In other cases, the synchronization process can be repeated, for example, every 100 ms, 500 ms, 1 s, 2 s, or another time value as appropriate for the particular application.

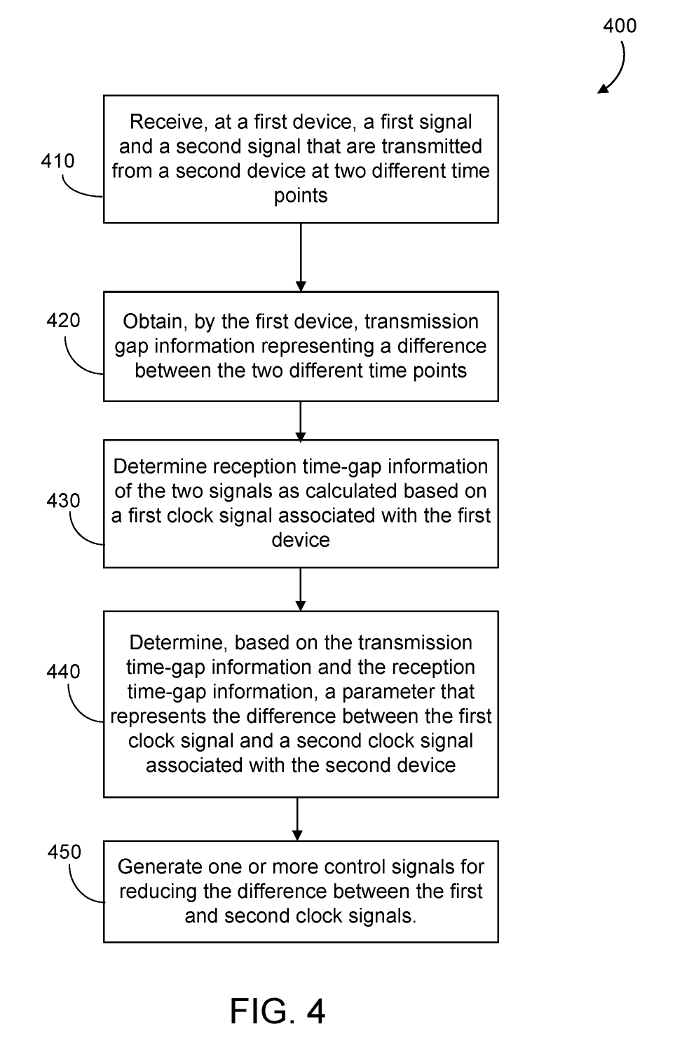

FIG. 4 is a flowchart of an example process 400 for reducing a difference between two clock signals. In some implementations, the process 400 can be executed, at least in part by the processing engine 220 of a receiving device 210. In executing the process 400, a processing engine 220 may communicate with a transceiver 225 and a clock 215 of the device. Operations of the process 400 includes receiving a first signal and a second signal at two different time points (410). The first and second signals are transmitted from another device (e.g., the transmitting device 205 described above with respect to FIG. 3) to which the receiving device synchronizes its clock. The transmitting device can be, for example, a master node in a network that maintains a master-clock for the network. In some implementations, the transmitting device may transmit the first and second signals responsive to the receiving device requesting a synchronization. In some implementations, both the first and second devices are acoustic transducers (e.g., speakers) associated with an audio system. In some implementations, the first and second signals can be transmitted over an infrared portion or a radio frequency portion of electromagnetic spectrum. A wavelength associated with the first signal can be substantially equal to a wavelength associated with the second signal.

Operations of the process 400 also includes obtaining transmission time-gap information representing a difference between the two time points (420). In some implementations, the difference between the two time-points can be calculated based on a clock signal associated with the transmitting device. The difference between the two time-points may also be calculated in accordance with a standardized time such as the UTC. In some implementations, information about the transmission time-gap (or the corresponding frequency) may be made available to the receiving device at a prior time point (e.g., when the device joins the network, or via a beacon signal transmitted to multiple devices connected to the network). The transmission time-gap information may be stored on a memory device accessible by the receiving device and obtained from the memory device by a processing engine associated with the receiving device.

The operations of the process further includes determining reception time-gap information representing a difference between two time points at which the first signal and the second signal are received, respectively, at the receiving device (430). This can be done, for example, by the processing engine of the receiving device in cooperation with the transceiver and clock of the receiving device. For example, the transceiver of the receiving device can notify the processing engine of the receipt of each of the two signals, and the processing engine can be configured to determine the reception time-gap information based on the clock associated with the receiving device.

The operations of the process 400 also includes determining, based on the transmission time-gap information and the reception time-gap information, at least one parameter that represents the difference between the clock signals used in calculating the transmission time-gap and the reception time-gap, respectively (440). For example, if the reception time-gap is longer than the transmission time-gap, the clock of the receiving device is determined to be running slower (i.e., at a lower frequency or slower clock-speed) than the clock used for determining the transmission time-gap. Conversely, if the reception time-gap is shorter than the transmission time-gap, the clock of the receiving device is determined to be running faster (i.e., at a higher frequency or faster clock-speed) than the clock used for determining the transmission time-gap. In some implementations, the at least one parameter can represent an offset or drift between the two clocks.

The operations of the process 400 also includes generating one or more control signals for reducing the difference between the first and second clock signals (450). In some implementations, the one or more control signals can be configured to adjust the clock associated with the receiving device. In some implementations, the one or more control signals may be transmitted to the transmitting device to adjust the clock associated with the transmitting device. The one or more control signals are configured to adjust one or both clocks such that the difference between the two clocks (as represented, for example, by the calculated parameter) is reduced. For example, the one or more control signals can be configured to adjust the clock-speed (or frequency) of the receiving device clock such that the difference in clock-speed between the two clocks is reduced. In some implementations, the entire correction is not applied at once, but via an iterative process that causes the correction to be applied over multiple times and in smaller amounts. For example, if the calculated parameter indicates a 1 ms drift between the two clocks, the correction process may be executed over 10 ms and include ten separate corrections of 0.1 ms at intervals of 1 ms. In some implementations, where the receiving device is synchronizing with a master-clock, the one or more control signals can be configured to adjust the clock of the receiving device such that the adjusted clock is in phase lock with the master-clock.

The first and second signals may be received multiple times, for example, to periodically synchronize the clock of the receiving device with that of the transmitting device. In such cases, multiple sets of one or more control signals, can be generated, wherein each set of control signals is based on a corresponding set of the first and second signals. In some implementations, the parameter indicative of the difference between the two clocks may be calculated for each set of first and second signals, and control signals to correct the difference may be generated accordingly.

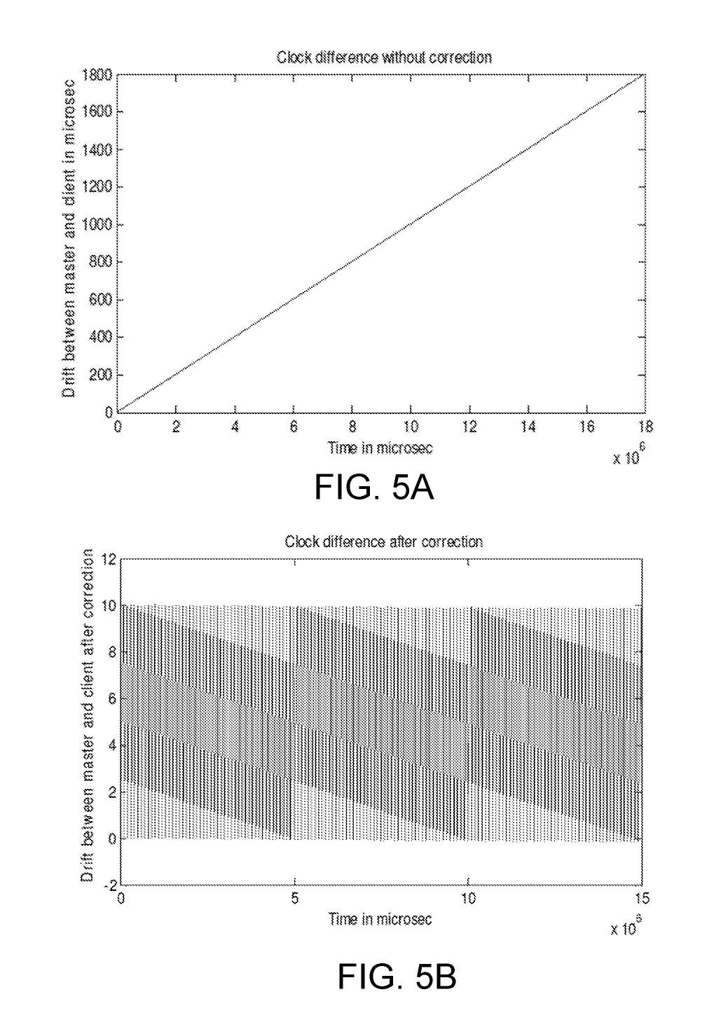

FIGS. 5A and 5B are example plots illustrating the effects of the techniques described herein. In this experiment, one master clock and one device clock were used. The drift characteristics were modeled as a normal distribution with a mean of 100 μs/s and variance of 10 μs/s. The synchronization was performed every 10 ms, and the corrections were applied every 100 ms. FIG. 5A illustrates that the drift varied substantially linearly over time in the absence of any correction or synchronization. However, as illustrated in FIG. 5B, the periodic correction in accordance with the techniques described above limited the maximum drift to only 10 μs. It should be noted that the examples of FIGS. 5A and 5B are for illustrative purposes and should not be considered to be limiting. Other variations are also possible. For example, the correction can be applied more aggressively (e.g., by applying a larger correction at each iteration, or applying the correction more frequently) to further limit the maximum drift.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a DSP, a microcontroller, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed one or more processing devices at one site or distributed across multiple sites and interconnected by a network.

Actions associated with implementing all or part of the functions can be performed by one or more programmable processors or processing devices executing one or more computer programs to perform the functions of the processes described herein. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

A number of implementations have been described. However, other embodiments not specifically described in details are also within the scope of the following claims. For example, the synchronization techniques described herein may be applied for synchronizing clocks that separately time the circuitry in the left and right earpieces of a headset. In some implementations, where signals are sent separately to the two earpieces, this can result in fast and accurate synchronization, thereby potentially reducing any undesirable effects resulting from different delays in the two earpieces. Also, while the technology is primarily described using examples of devices connected to one another via wireless networks, the technology may also be applied to wired or mesh networks. For example, in communication applications where two devices connected over a wired network are physically separated by a significant distance, synchronizing their respective clocks without calculating a round trip delay may result in faster synchronization process, particularly if such synchronization is performed repeatedly.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein. While this invention has been particularly shown and described with references to preferred embodiments thereof, it will be understood by those skilled in the art that various changes in form and details may be made therein without departing from the spirit and scope of the invention, as defined by the appended claims.

What is claimed is:

1. A computer-implemented method for reducing a difference between two clock signals, the method comprising:
receiving, at a first device, a first signal and a second signal, wherein the first and second signals are transmitted from a second device over a wireless channel at two different time points;
obtaining, by the first device, transmission time-gap information representing a difference between the two different time points;
determining, using one or more processors of the first device, reception time-gap information representing a difference between two time points at which the first signal and the second signal are received, respectively, at the first device, wherein the reception time-gap information is calculated based on a first clock signal associated with the first device;
determining, based on the transmission time-gap information and the reception time-gap information, at least one parameter that represents the difference between the first clock signal and a second clock signal associated with the second device; and
generating, based on the at least one parameter, one or more control signals for reducing the difference between the first and second clock signals.

2. The method of claim 1, wherein the difference between the two time points is calculated based on the second clock signal associated with the second device.

3. The method of claim 1, wherein the at least one parameter represents an offset between the first and second clock signals.

4. The method of claim 3, wherein at least one of the control signals is configured to adjust the first clock signal such that the offset between the first and second clock signals is reduced.

5. The method of claim 1, wherein the at least one parameter represents a difference in clock-speeds of the first and second clock signals, respectively.

6. The method of claim 5, wherein at least one of the control signals is configured to adjust the clock-speed of the first clock such that the difference in clock-speeds is reduced.

7. The method of claim 1, wherein each of the first and second devices is a speaker associated with an audio system.

8. The method of claim 1, wherein the first and second signals are transmitted from the second device multiple times.

9. The method of claim 8, further comprising generating multiple sets of one or more control signals, each of which is generated based on a corresponding set of the first and second signals.

10. The method of claim 8, further comprising:
receiving, at the first device, a third signal that is transmitted from the second device;
obtaining, by the first device, transmission time-gap information representing a difference between transmission times of the second signal and the third signal;
determining a second reception time-gap information representing a difference between two time points at which the second signal and the third signal are received, respectively, at the first device, in accordance with the first clock signal associated with the first device; and
determining the at least one parameter based also on the second reception time-gap information.

11. The method of claim 1, wherein:
the at least one parameter is determined multiple times, and
the one or more control signals are generated based on the multiple values of the at least one parameter.

12. The method of claim 1, wherein the first and second signals are transmitted over an infrared portion or a radio frequency portion of electromagnetic spectrum.

13. The method of claim 1, wherein a wavelength associated with the first signal is substantially equal to a wavelength associated with the second signal.

14. The method of claim 1, wherein the second clock signal is a master-clock signal for a network of wireless devices.

15. The method of claim 1, wherein the first and second signals are transmitted as portions of corresponding clear-to-send (CTS) packets.

16. The method of claim 15, wherein each of the CTS packets is a CTS-to-self packet in which an address field includes an address of the second device.

17. A system comprising:
a clock configured to generate a first clock signal;
a receiver device configured to:
receive a first signal and a second signal, wherein the first and second signals are transmitted from a second device over a wireless channel at two different time points; and
one or more processing devices configured to:
obtain transmission time-gap information representing a difference between the two different time points,
determine reception time-gap information representing a difference between two time points at which the first signal and the second signal are received, respectively, at the receiver device, wherein the reception time-gap information is calculated based on the first clock signal,
determine, based on the transmission time-gap information and the reception time-gap information, at least one parameter that represents the difference between the first clock signal and a second clock signal associated with the second device, and
generate, based on the at least one parameter, one or more control signals for reducing the difference between the first and second clock signals.

18. The system of claim 17, wherein the difference between the two time points is calculated based on the second clock signal associated with the second device.

19. The system of claim 17, wherein the at least one parameter represents an offset between the first and second clock signals.

20. The system of claim 19, wherein at least one of the control signals is configured to adjust the first clock signal such that the offset between the first and second clock signals is reduced.

21. The system of claim 17, wherein the clock, the receiver device, and the one or more processing devices are disposed in a speaker associated with an audio system.

22. The system of claim 17, wherein the one or more processing devices are configured to determine the at least one parameter multiple times, and generate the one or more control signals multiple times based on the different values of the at least one parameter.

23. The system of claim 17, wherein the second clock signal is a master-clock signal for a network of wireless devices.

24. The system of claim 17, wherein the first and second signals are transmitted as portions of corresponding clear-to-send (CTS) packets.

25. One or more machine-readable storage devices having encoded thereon computer readable instructions for causing one or more processors to perform operations comprising:
receiving a first signal and a second signal, wherein the first and second signals are transmitted from a second device over a wireless channel at two different time points;
obtaining transmission time-gap information representing a difference between the two different time points;
determining reception time-gap information representing a difference between two time points at which the first signal and the second signal are received, respectively, wherein the reception time-gap information is calculated based on a first clock signal;
determining, based on the transmission time-gap information and the reception time-gap information, at least one parameter that represents the difference between the first clock signal and a second clock signal associated with another device; and
generating, based on the at least one parameter, one or more control signals for reducing the difference between the first and second clock signals.
